(19) United States
(12) Patent Application Publication
(10) Pub. No.: US 2013/0033453 A1
(43) Pub. Date: Feb. 7, 2013

(54) METHOD FOR OPERATING AND CONTROLLING ELECTRONIC EQUIPMENT AND ELECTRONIC EQUIPMENT

(71) Applicant: Junfeng Liu, Beijing (CN)

(72) Inventor: Junfeng Liu, Beijing (CN)

(73) Assignee: Beijing Lenovo Software Ltd., Haidian District, Bejing (CN)

(21) Appl. No.: 13/641,547

(22) PCT Filed: Apr. 7, 2011
(86) PCT No.: PCT/CN2011/072508

§ 371 Date: Oct. 16, 2012

(30) Foreign Application Priority Data
Apr. 16, 2010 (CN) 201010152179.4

(51) Int. Cl. G06F 3/045

(52) U.S. Cl. 345/174

(57) ABSTRACT

A method for operating and controlling an electronic equipment and an electronic equipment are described. The electronic equipment includes a first touch induction unit and a display unit set on a first surface, a second touch induction unit set on a second surface, such that the first surface is different from the second surface. The method includes obtaining a first operation information when the second touch induction unit is operated; according to the first operation information, popping-up a menu on the display unit; obtaining a second operation information when the menu on the first touch induction unit or the second touch induction unit is operated; producing an operation control information corresponding to the second operation information; according to the operation control information, and operating an object displayed on the display unit.

This application claims priority to International Application No. PCT/CN2011/072508 filed on Apr. 7, 2011 and to CN 201010152179.4 filed on Apr. 16, 2010, the entire contents of incorporated herein by reference.

### BACKGROUND

The present invention relates to a portable electronic equipment, and particularly refers to a method for operating and controlling an electronic equipment provided with double touch induction units and an electronic equipment.

At present, the touch screens which are widely used on a portable electronic equipments such as mobile phones, are basically single-side. Since touch operations can only be performed on the touch screen, all functions related to the touch operations need to be accomplished on the touch screen, and thereby the phenomena of inconvenient operation, false triggering and so on are arising, wherein the case of inconvenient operation can be a menu similar to the menu popping up when click the right button of a mouse can not pop up on the touch screen.

During the process of the implementation of the present invention, the inventor has found that there exists at least the following problems in the art:

The problems of inconvenient operation and false triggering exist in the operations of existing electronic equipments.

### SUMMARY

The technical problem to be solved in the present invention is providing a method for operating and controlling an electronic equipment and an electronic equipment, which can avoid the false triggering problems on a touch induction unit, to make the operation convenient.

In order to solve the above technical problem, the technical solutions of embodiments of the present invention are as follows:

A method for operating and controlling an electronic equipment is provided in the embodiments of the present invention, and the electronic equipment is provided with a first touch induction unit and a display unit disposed on a first surface and a second touch induction unit disposed on a second surface, the first surface is different with the second surface; the method comprises:

obtaining an operation information of an operation on the second touch induction unit;

generating an operation control information corresponding to the operation information; and

operating, according to the operation control information, an object displayed on the display unit.

Preferably, the operation information of an operation on the second touch induction unit is specifically an operation information of a click on the second touch induction unit; and

the operation control information corresponding to the operation information of a click is a menu popping up when the object is clicked.

A method for operating and controlling an electronic equipment is provided in the embodiments of the present invention, and the electronic equipment is provided with a first touch induction unit and a display unit disposed on a first surface and a second touch induction unit disposed on a second surface, the first surface is different with the second surface; the method comprises:

obtaining a first operation information of an operation on the second touch-sensitive unit;

popping up, according to the first operation information, a menu on the display unit;

obtaining a second operation information of an operation the menu on the first touch induction unit or the second touch induction unit;

generating an operation control information corresponding to the second operation information; and

operating, according to the operation control information, an object displayed on the display unit.

Preferably, the first operation information is specifically an operation information of a click on the second touch induction unit;

the second operation information is specifically an operation information of a click or a swipe on the first touch induction unit or an operation information of a click or a swipe on the second touch induction unit; and

the menu includes at least one menu item, and the operation control information is specifically a selection information which indicates the menu item selected by a way of a click or a swipe on the first touch induction unit or a menu item selected by a way of a click or a swipe on the second touch induction unit.

Preferably, the operation of a swipe is a rectilinear swipe or a curved swipe.

A method for operating and controlling an electronic equipment is provided in the embodiments of the present invention, and the electronic equipment is provided with a first touch induction unit and a display unit disposed on a first surface and a second touch induction unit disposed on a second surface, the first surface is different with the second surface; the method comprises:

obtaining an operation information of an operation on the first and the second touch induction units when the first and the second touch induction units detect being operated simultaneously;

generating a operation control information corresponding to the operation information; and

operating, according to the operation control information, an object displayed on the display unit.

Preferably, the operation information is an operation information of the first and the second touch induction units detecting being touched simultaneously; and

the operation control information corresponding to the operation information is a menu popping up when the object is operated.

Preferably, the first and the second surfaces are two relative surfaces of the electronic equipment, the first touch induction unit overlaps with the display unit, wherein,

the operation information is an operation information of the first and the second touch induction units simultaneously detecting being touched and a swipe; and

the operation control information is a control instruction corresponding to the operation information.

Preferably, a projection distance between a first touch point on the first touch induction unit and a second touch point on the second induction unit is less than a pre-defined threshold when the first and the second touch induction units are touched;

the swipes are swipes in a same direction on the first and the second touch induction units.

A method for operating and controlling an electronic equipment is provided in the embodiments of the present invention, and the electronic equipment is provided with a first touch induction unit and a display unit disposed on a first surface and a second touch induction unit disposed on a second surface, the first surface is different with the second surface; the method comprises:

obtaining a third operation information of an operation on the first and the second touch induction units when the first and the second touch induction units detect being operated simultaneously;

popping up, according to the third operation information, a menu on the display unit;

obtaining a fourth operation information of an operation the menu on the first and the second touch induction units simultaneously;

generating an operation control information corresponding to the fourth operating information; and

operating, according to the operation control information, an object displayed on the display unit.

Preferably, the third operating information is an operation information of the first and the second touch induction units detecting being touched simultaneously;

the fourth operation information is an operation information of a click or a swipe on the first touch induction unit or an operation information of a swipe on the first and the second touch-sensitive units simultaneously; and

the menu includes at least one menu item, and the operation control information is specifically a selection information which indicates the menu item selected by a way of a click or a swipe on the first touch induction unit or a menu item selected by a way of a swipe on the first and the second touch induction units simultaneously.

Preferably, the first and the second surfaces are two relative surfaces of the electronic equipment; the first touch induction overlaps with the second touch induction unit, wherein, the menu pops up at the relative position of the display unit corresponding to the first touch point on the first touch induction unit.

Preferably, the menu item of the menu is determined according to the operation on the displayed object on the display unit; and

the object on the display unit has at least one attribute information, and when the object is operated, the attribute information according to the selected menu item is searched, and the selected menu item is executed according to the searched attribute information, and the object is operated.

A method for operating and controlling an electronic equipment is provided in the embodiments of the present invention, and the electronic equipment is provided with a first touch induction unit and a display unit disposed on a first surface and a second touch induction unit disposed on a second surface, the first surface is different with the second surface; the method comprises:

the second detecting circuit is used for obtaining the operation information of an operation on the second touch surface; and

the main control unit comprises:

a control module for generating a operation control information corresponding to the operation information;

an operation executing module for operating, according to the operation control information, an object displayed on the display unit.

An electronic equipment is also provided in the embodiments of the present invention, comprising: a first touch induction unit and a display unit disposed on a first surface of the electronic equipment; a second touch induction unit disposed on a second surface of the electronic equipment; and a main control unit connected respectively to the first and the second touch induction units; wherein, the first touch induction unit includes a first touch surface and a first detecting circuit; the second touch induction unit includes a second touch surface and a second detecting circuit; the first surface is different with the second surface;

the second detecting circuit is used for obtaining a first operation information of an operation on the second touch surface; and

the main control unit comprises a first control module for popping up, according to the first operation information, a menu on the display unit;

the first detecting circuit is used for obtaining a second operation information of an operation the menu on the first touch surface, or the second detecting circuit is also used for obtaining the second information of operating the menu on the second touch surface;

the main control unit further comprises: a second control module for generating an operation control information corresponding to the second operation information;

an operation executing module for operating, according to the operation control information, an object displayed on the display unit.

Preferably, the first operation information is specifically an operation information of a click on the second touch surface, which is detected by the first detecting circuit;

the second operation information is specifically an operation information of a click or a swipe on the first touch surface, which is detected by the first detecting circuit or an operation information of a click or a swipe on the second touch surface, which is detected by the second detecting circuit; and

the menu includes at least one menu item, and the operation control information is specifically a selection information which indicates a menu item selected by a way of a click or a swipe on the first touch surface or a menu item selected by a way of a click or a swipe on the second touch surface.

An electronic equipment is also provided in the embodiments of the present invention, comprising: a first touch induction unit and a display unit disposed on a first surface of the electronic equipment; a second touch induction unit disposed on a second surface of the electronic equipment; and a main control unit connected respectively to the first and the second touch induction units; wherein, the first touch induction unit includes a first touch surface and a first detecting circuit; the second touch induction unit includes a second touch surface and a second detecting circuit; the first surface is different with the second surface;

obtaining a operation information of an operation on the first and the second touch surfaces when the first and the second detecting circuits detect the first and the second touch surfaces are operated simultaneously;

the main control unit comprises:

a control module for generating a operation control information corresponding to the operating information; and

an operation executing module for operating, according to the operation control information, an object displayed on the display unit.

Preferably, the first and the second surfaces are two relative surfaces of the electronic equipment, and the first touch induction unit overlaps with the display unit; the operation information is an operation information of the first and the second touch surfaces being touched and a swipe simultaneously, which is detected by the first and the second detecting circuits; and

the operation control information is a control instruction corresponding to the operation information.

An electronic equipment is also provided in the embodiments of the present invention, comprising: a first touch induction unit and a display unit disposed on a first surface of the electronic equipment; a second touch induction unit disposed on a second surface of the electronic equipment; and a main control unit connected respectively to the first and the second touch induction units; wherein, the first touch induction unit includes a first touch surface and a first detecting circuit; the second touch induction unit includes a second touch surface and a second detecting circuit; the first surface is different with the second surface;

obtaining a third operation information of an operation on the first and the second surfaces when the first and the second detecting circuits detect the first and the second touch surfaces are operated simultaneously;

the main control unit comprises: a third control module for popping up, according to the third operation information, a menu on the display unit;

the first and the second detecting circuits obtain a fourth operation information of an operation the menu on the first and the second touch surfaces simultaneously;

the main control unit further comprises: a fourth control module for generating a operation control information corresponding to the fourth operation information; and

an operation executing module for operating, according to the operation control information, an object displayed on the display unit.

Preferably, the third operating information is an operation information of the first and the second touch surfaces being touched simultaneously, which is detected by the first and the second detecting circuits;

the fourth operation information is an operation information of a click or a swipe on the first touch surface, which is detected by the first detecting circuit, or an operation information of a swipe on the first and the second touch surfaces, which is detected by the first and the second detecting circuits simultaneously; and

the menu includes at least one menu item, and the operation control information is specifically a selection information which indicates a menu item selected by a way of a click or a swipe on the first touch induction unit or a menu item selected by a way of a swipe on the first and the second touch surfaces simultaneously.

The beneficial effects of the embodiments of the present invention are as follows:

In the above solutions, a relative operation control information is generated by detecting, in a double sided tangible electronic equipment, the operation information on the second touch induction unit of the electronic equipment, and a relative operation for an displayed object which lies on the display unit of the first surface of the electronic equipment is performed according to the operation control information; or an operation is performed on the first and the second touch induction units simultaneously, and a relative operation control information is generated, so that a relative operation for an object on the display unit of the first surface is performed according to the operation control information, which solves the problem of false triggering which often occurs on the single sided touch induction unit, and it improves the efficiency of the touch control, and brings richer gestures, thereby making the users convenient to use.

### BRIEF DESCRIPTION OF THE DRAWINGS

FIG. 1 is a drawing of the front structure of an electronic equipment of the present invention;

FIG. 2 is a drawing of the back structure of the electronic equipment shown in FIG. 1;

FIG. 3 is a flowchart of a first embodiment of a method for operating and controlling an electronic equipment of the present invention;

FIG. 4 is a flowchart of a second embodiment of a method for operating and controlling an electronic equipment of the present invention;

FIG. 5 is a schematic drawing of operations of pressing and swiping in a rectilinear motion on the first touch induction unit and/or the second touch induction unit of the electronic equipment;

FIG. 6 is a schematic drawing of operations of pressing and swiping in a curved motion on the first touch induction unit and/or the second touch induction unit of the electronic equipment;

FIG. 7 is a schematic drawing of the direction of the swipe in a curved motion shown in FIG. 6;

FIG. 8 is a flowchart of a third embodiment of a method for operating and controlling an electronic equipment of the present invention;

FIG. 9 is an instance diagram of a four-way menu of operating on the front and the back surfaces of the electronic equipment simultaneously;

FIG. 10 is an instance diagram of the circular menu of operating on the front and the back surfaces of the electronic equipment simultaneously;

FIG. 11 is a flowchart of a fourth embodiment of a method for operating and controlling an electronic equipment of the present invention;

FIG. 12 is an effect drawing when the object displayed on the display unit of the electronic equipment is an address book.

FIG. 13 is a drawing of the structure of the electronic equipment of the present invention;

FIG. 14 is a flowchart of a first specific implementation of operating and controlling the electronic equipment of the present invention;

FIG. 15 is a flowchart of a second specific implementation of operating and controlling the electronic equipment of the present invention.

### DETAILED DESCRIPTION

To make objectives, technical solutions and advantages of the present invention more clearly, a detailed description of the embodiments of the present invention will be given below in connection with the accompanying drawings.

For the problems of false triggering and inconvenient use existing in the existing electronic equipments in the art, a method for operating and controlling an electronic equipment and an electronic equipment is provided in the present invention, which can avoid the problem of false triggering on the touch induction unit, thereby making users convenient to use.

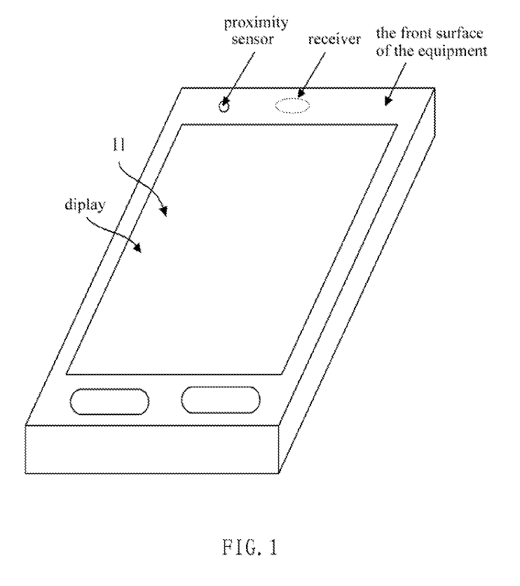

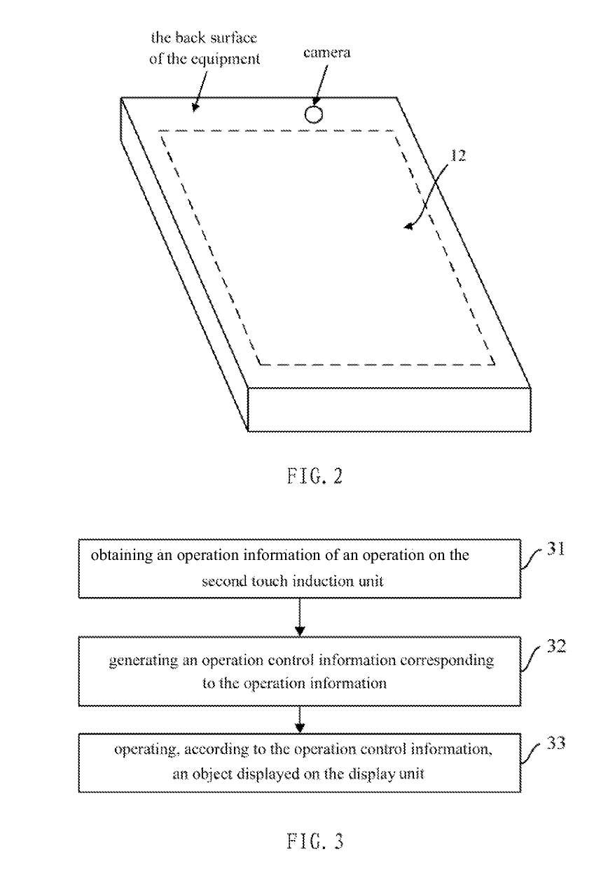

As shown in FIG. 1 and FIG. 2, the electronic equipment in the present invention is an electronic equipment provided with two touch induction units. The front structure of the electronic equipment is shown in FIG. 1, comprising: a first touch-sensitive unit 11 and a display unit which can be specifically a LCD display. The display unit and the first touch induction unit are set overlappingly. The overlapping setting refers to the overlap in the direction which is perpendicular with the display unit and the touch induction unit. Certainly, the display may not overlap with the first touch induction unit. Additionally, the size of the display unit has nothing to do with the first touch induction unit. If the two parts are set overlappingly, the first touch induction unit can be bigger than the display unit, and if the two parts are not overlapped, the first touch induction unit can be bigger than, smaller than, or equivalent to the display unit. The second touch induction unit 12 in the back surface of the electronic equipment is shown in FIG. 2. The size of the second touch induction unit can be bigger than, smaller than, or equivalent to the first touch induction unit of the front surface. The shape of the second touch induction unit can be rectangular, or a shape of H, and the second touch induction unit can lie in anywhere around the frame of the electronic equipment.

### Embodiment 1

As shown in FIG. 3, a method for operating and controlling an electronic equipment is provided, wherein the electronic equipment is provided with a first touch induction unit and a display unit disposed on a first surface and a second touch induction unit disposed on a second surface; the first surface is different with the second surface; the first surface of the electronic equipment can be the front surface of the electronic equipment shown in FIG. 1, and the second surface of the electronic equipment can be the back surface of the electronic equipment shown in FIG. 2.

The method comprises:

Step 31, obtaining an operation information of an operation on the second touch induction unit;

Step 32, generating an operation control information corresponding to the operation information; and

Step 33, operating, according to the operation control information, an object displayed on the display unit.

Wherein, in the above Step 31, the operation information of an operation on the second touch induction unit is specifically an operation information of a click on the second touch induction unit; and

the operation control information corresponding to the operation information of a click is a menu popping up when the object is clicked.

Specifically, the menu which pops up when a click is performed on the second touch induction unit can be similar to a menu which pops up when a click is performed on the right button of a mouse in the traditional computer use environment. The menu pops up immediately with a quick response and no wait for the user when a user performs a click on the second touch induction unit, which improves the user's operating efficiency for the electronic equipment.

In the embodiment an operation information for the second induction unit set on the second surface of the electronic equipment is obtained, according to the operation information to generate an operation control information, and further according to the operation control information. In the embodiment, the operation information corresponding to the operation on the first touch induction unit is different with the operation information corresponding to the operation on the second touch induction unit if the operation is performed on the first touch induction unit. In this embodiment, the relative operation control effect to the objects displayed on the display unit can also be generated by operating on the second touch induction unit of the electronic equipment, rather than operating merely on the first touch induction unit to avoid the false triggering phenomena on the first touch-sensitive unit.

### Embodiment 2

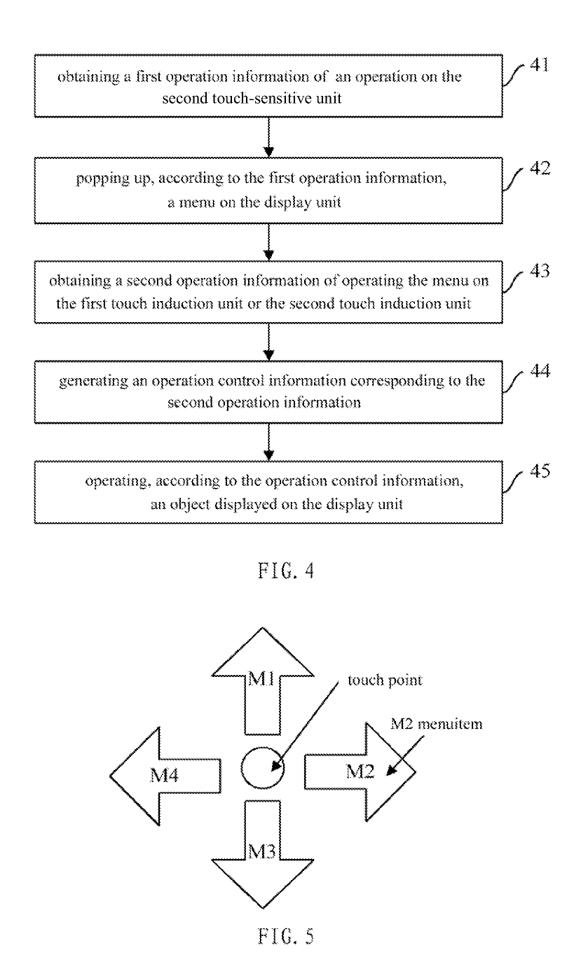

As shown in FIG. 4, a method for operating and controlling an electronic equipment is provided, wherein the electronic equipment is provided with a first touch induction unit and a display unit disposed on a first surface and a second touch induction unit disposed on a second surface; the first surface is different with the second surface; the first surface of the electronic equipment can be the front surface of the electronic equipment shown in FIG. 1, and the second surface of the electronic equipment can be the back surface of the electronic equipment shown in FIG. 2.

The method comprises:

Step 41, obtaining a first operation information of an operation on the second touch-sensitive unit;

Step 42, popping up, according to the first operation information, a menu on the display unit;

Step 43, obtaining a second operation information of an operation the menu on the first touch induction unit or the second touch induction unit;

Step 44, generating an operation control information corresponding to the second operation information; and

Step 45, operating, according to the operation control information, an object displayed on the display unit.

In above Step 41, the first operation information is specifically an operation information of a click on the second touch induction unit; the second operation information is specifically an operation information of a click or a swipe on the first touch induction unit; and the menu includes at least one menu item, and the operation control information is specifically a selection information which indicates the menu item selected by a way of a click or a swipe on the first touch induction unit

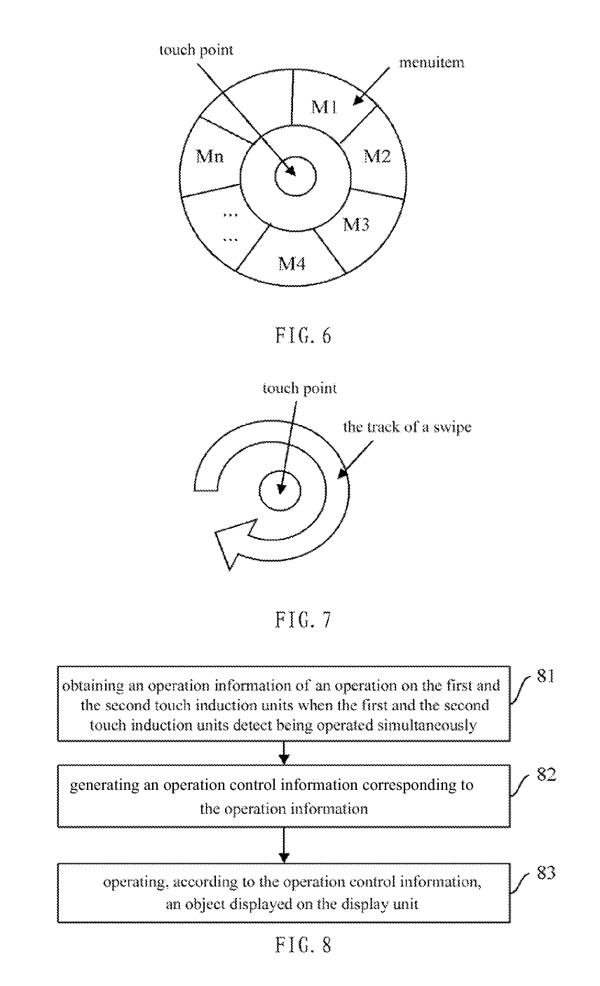

Specifically, when a click is performed on the second touch induction unit on the back surface of the electronic equipment (the touch point shown in FIG. 5 or FIG. 6 is the touch position on the second induction unit), a menu similar to the menu of the right button of a mouse pops up on the display of the first surface of the electronic equipment. At the moment, if the display unit does not overlap with the first touch induction unit, a swipe in a certain direction on the first touch incution unit can be performed to select a menu item in the direction. If the display unit overlaps with the first touch induction unit, a click on a certain menu item or a swipe to a certain menu item can be performed on the first touch induction unit to select the menu item. The menu can be a list menu or a directional menu. The list menu can be a common vertical list menu or a circular list menu shown in FIG. 6, and the directional menu can be a four-way menu shown in FIG. 5 or an eight-way menu.

Certainly, a certain menu item can also be selected in a way of a swipe on the first touch induction unit. In the four-way menu shown in FIG. 5, using the touch point as a start point, a swipe in a linear motion is performed to select any of a menu item in M1-M4.

Alternatively, in the circular menu shown in FIG. 6, one menu item in M1-Mn can be selected in a way of a swipe in a curved motion, and FIG. 7 shows the direction of the curved swipe of the circular menu shown in FIG. 6. In the circular menu shown in FIG. 6, a swipe can be performed in the direction of the arrow shown in FIG. 7, or in a direction opposite to the direction of the arrow shown in FIG. 7 to select the menu item. Alternatively, the touch point shown in FIG. 6 can be used as a start point of the swipe, a certain menu item can be reached by a straight swipe, and thus the menu item is selected.

In above Step 41, when the first operation information is specifically an operation information of a click on the second touch induction unit, the second operation information specifically can also be an operation information of a click or a swipe on the second touch induction unit. Accordingly, the operation control information is specifically a selection information which indicates the menu item selected by a way of a click or a swipe on the second touch induction unit. The second click on the second touch induction unit is similar to the function of a click on left button of a mouse, which can directly select a certain item in a list menu or a directional menu. The list menu can be a common vertical list menu or a circular list menu shown in FIG. 6, and the directional menu can be a four-way menu shown in FIG. 5 or an eight-way menu. The specific embodiment of selecting one menu item in the menu in a way of a swipe on the second touch induction unit can also be, in the four-way menu shown in FIG. 5, using the touch point as a start, performing a rectilinear swipe to select any of a menu item in M1-M4, or selecting any of a menu item in M1-Mn in the circular menu shown in FIG. 6 in a way of a swipe in a curved motion. FIG. 7 shows the direction the swipe on the circular menu shown in FIG. 6.

The operation of a swipe specifically can be a rectilinear swipe or a curved swipe. For example, a certain menu item of a list menu, a four-way menu, an eight-way menu or a circular menu can be selected in a way of a rectilinear swipe. A menu item of a circular menu can also be selected in a way of a curved swipe, such as the menu shown in FIG. 6 specifically.

The operation equivalent to the left button of a mouse is accomplished in the first touch induction unit on the front surface and the operation equivalent to the right button of a mouse is completed in the second touch induction unit on the back surface in Embodiment 2 of the present invention. For example, when the positions of the second touch induction unit and the display unit is relative to each other, after a press (such as a click or a touch) is performed on the second touch induction unit, the display unit will pop up a menu at the position corresponding to the press (equivalent to the menu popping up when a click is performed on the right button of a mouse). The menu can be a list, a circular type, a four-way type, an eight-way type and so on. Then a certain menu item is selected with the finger swiping in a press state. Therefore, the problem that it is not easy to trigger the function of the right button of a mouse of a single-sided touch induction unit is solved, thereby improving the efficiency of the touch control, bringing richer gestures and making the users convenient to use.

### Embodiment 3

As shown in FIG. 8, a method for operating and controlling an electronic equipment is provided, wherein the electronic equipment is provided with a first touch induction unit and a display unit disposed on a first surface and a second touch induction unit disposed on a second surface; the first surface is different with the second surface; the first surface of the electronic equipment can be the front surface of the electronic equipment shown in FIG. 1, and the second surface of the electronic equipment can be the back surface of the electronic equipment shown in FIG. 2.

The method comprises:

Step 81, obtaining an operation information of an operation on the first and the second touch induction units when the first and the second touch induction units detect being operated simultaneously;

Step 82, generating a operation control information corresponding to the operation information; and

Step 83, operating, according to the operation control information, an object displayed on the display unit.

In Step 81, the operation information is an operation information of the first and the second touch induction units detecting being touched simultaneously. Accordingly, the operation control information corresponding to the operation information is a menu popping up when the object is operated. Specifically, the popping up menu can be similar to a menu popping up when a click is performed on the right button of a mouse. The “simultaneously” here refers to a touch is performed on the first and the second touch induction units at the same time, or it also can refer to a touch is performed on the second touch induction unit with the first touch induction unit kept in touch.

In this situation, when a touch or a swipe with a touch is performed simultaneously on the first touch induction unit lies on the front surface of the electronic equipment and the second touch induction unit lies on the back surface of the electronic equipment, the display unit will pop up a menu (equivalent to the menu popping up when a click is performed on the right button of a mouse) at the position corresponding to the press. Then objects can be operated according to the menu and the menu here can be a list, a circular type, a four-way type or an eight-way type.

Additionally, the first and the second surfaces are two relative surfaces of the electronic equipment, like the front surface shown in FIG. 1 and the back surface shown in FIG. 2. The first touch induction unit overlaps with the display unit.

Specifically, the first surface of the electronic equipment is provided with a first touch induction unit, under which is a display unit. For example, the first touch induction unit is a capacitive or resistance touch screen, and the display unit is a LCD display lying under the touch screen. An integrated circuit of the main control unit is under the touch screen.

In this situation, in Step 81, the operation information is an operation information of the first and the second touch induction units simultaneously detecting being touched and a swipe. For example, a press is performed simultaneously on the first and the second touch induction units, and then a swipe is performed in a certain direction.

Accordingly, the operation control information can be a control instruction corresponding to the operation information.

In this situation, a control instruction which is similar to the control instructions of popping up a menu and selecting a menu item from the menu is executed directly without popping up a menu on the display unit.

That is to say, when the type of an object is confirmed and an operation information to the object is obtained, a control operation information corresponding to the operation information of the object of the type is searched according to the operation information and the object of the type, and then the relative operations to the object are performed according to the operation control information.

For example, for a picture, when any point of the picture is pressed on the first and the second touch induction units simultaneously and a swipe is performed in a certain direction of the display unit, it represents zoom the picture in, and when a swipe is performed in the opposite direction of the certain direction, it represents zoom the picture out. Also, similar functions can be sending the picture or deleting the picture.

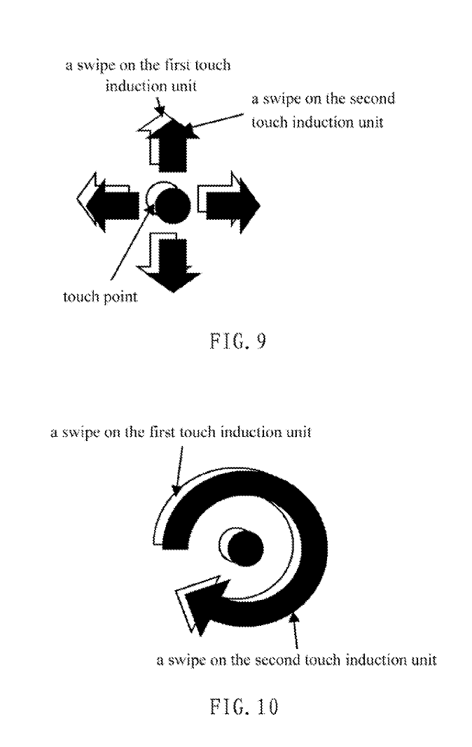

Additionally, when the operation information is an operation information of the first and the second touch induction units simultaneously detecting being touched and a swipe, a projection distance between a first touch point on the first touch induction unit and a second touch point on the second induction unit is less than a pre-defined threshold when the first and the second touch induction units are touched. The specific embodiments of the operations are shown in FIG. 9 and FIG. 10.

The touch points of users on the first and the second touch induction units do not coincide completely, but it is ok if, on the display unit, the projection distance between the touch points and the swiping tracks of an object on the display unit is less than a pre-defined threshold. The pre-defined threshold can be a user's touch points on the first and the second touch induction units are relative or approximately relative to each other, without beyond the scope of the display area on the display. In this situation,

the swipe on the first and the second touch induction units specifically can be a swipe in a same direction on the first and the second touch induction units. For example, on the display unit, the plane projection of the swiping tracks of the user' on the first and the second touch induction units coincide; or when swipes are performed in a rectilinear motion, on the display unit, the plane projection of the swiping tracks on the first and the second touch induction units are parallel to each other; or when swipes in a curved motion, on the display unit, the plane projection of the swiping tracks on the first and the second touch induction units can coincide when a pre-defined distance is moved.

In this situation, a touch and a swipe is performed on the first and the second touch induction units directly and simultaneously without popping up a menu; a operation control instruction corresponding to the operations of the touch and the swipe are generated directly; the relative operations to an object on the display unit according to the operation control instruction. For example, it represents zooming a picture in to press a picture on the two touch induction units simultaneously and then to swipe in a certain direction.

Compared with the art, in which various operations are only performed on one touch induction unit, which is easy to cause the problem of false triggering, the embodiment of the present invention just solve the problem of false triggering which often occurs on the single-sided touch induction unit, and it improves the efficiency of the touch control, and brings richer gestures, thereby making the users convenient to use.

### Embodiment 4

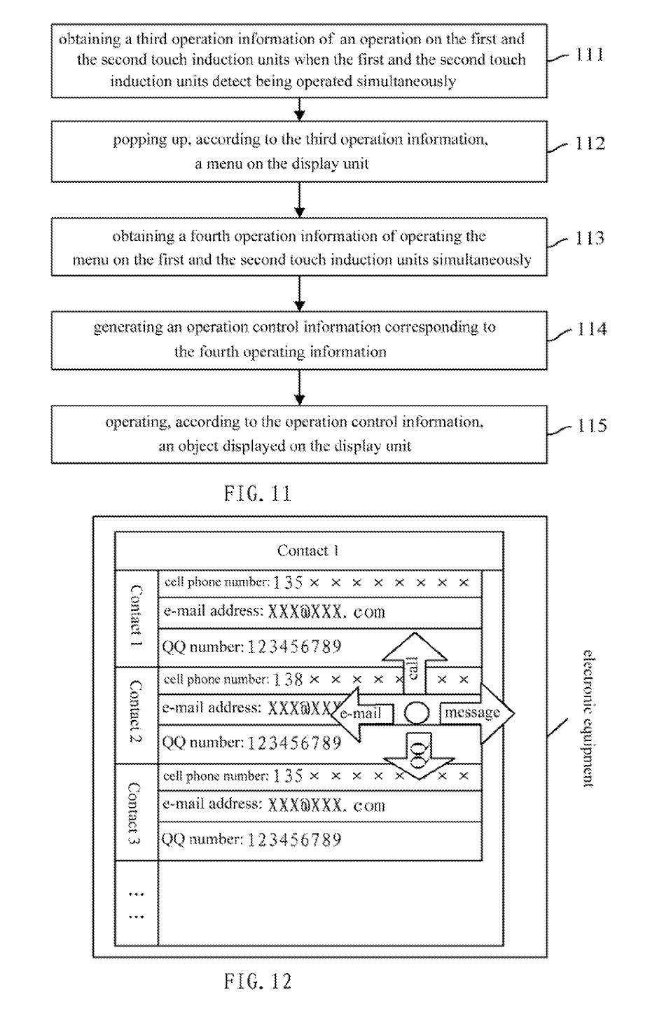

As shown in FIG. 11, a method for operating and controlling an electronic equipment is provided, wherein the electronic equipment is provided with a first touch induction unit and a display unit disposed on a first surface and a second touch induction unit disposed on a second surface; the first surface is different with the second surface; the first surface of the electronic equipment can be the front surface of the electronic equipment shown in FIG. 1, and the second surface of the electronic equipment can be the back surface of the electronic equipment shown in FIG. 2.

The method comprises:

Step 111, obtaining a third operation information of an operation on the first and the second touch induction units when the first and the second touch induction units detect being operated simultaneously;

Step 112, popping up, according to the third operation information, a menu on the display unit;

Step 113, obtaining a fourth operation information of an operation the menu on the first and the second touch induction units simultaneously;

Step 114, generating an operation control information corresponding to the fourth operating information;

Step 115, operating, according to the operation control information, an object displayed on the display unit.

Wherein, in above Step 111, the third operating information is an operation information of the first and the second touch induction units detecting being touched simultaneously. At this moment, on the display unit, a menu which is similar to the menu popping up when a click is performed on the right button of a mouse pops up according to the operation information of the first and the second touch induction units detecting being touched simultaneously.

The fourth operation information is an operation information of a click or a swipe on the first touch induction unit.

The menu includes at least one menu item, and the operation control information is specifically a selection information which indicates the menu item selected by a way of a click or a swipe on the first touch induction unit.

That is to say, in the popping up menus, an operation which is similar to a click on the left button of a mouse is performed on the first touch induction unit. For example, when the first touch induction unit overlaps with the display unit, click the area corresponding to a certain menu item of the menu directly to select the menu item, and the processor of the electronic equipment will perform, according to the executing instruction corresponding to the menu item, a relative operation to the objects on the display unit. Certainly, a certain menu item can also be selected in a way of a swipe. For example, when the menu is a four-way menu, one of the menu items can be selected in a rectilinear motion. If the first touch induction unit does not overlap with the display unit, a menu item in a certain direction can be selected by a swipe in the certain direction on the first touch induction unit.

Additionally, in above Step 111, the third operating information is an operation information of the first and the second touch induction units detecting being touched simultaneously. At this moment, on the display unit, a menu which is similar to the menu popping up when a click is performed on the right button of a mouse pops up according to the operation information of the first and the second touch induction units detecting being touched simultaneously.

the fourth operation information is an operation information of a swipe on the first and the second touch-sensitive units simultaneously.

Accordingly, the operation control information is specifically a menu item selected by a way of a swipe on the first and the second touch induction units simultaneously. The effect of the operation is the same as the above mentioned effect of selecting a menu item on the first touch induction unit only, which is unnecessary to go into details here.

Furthermore, in the embodiment, he first and the second surfaces are two relative surfaces of the electronic equipment; the first touch induction overlaps with the second touch induction unit, wherein, the menu pops up at the relative position of the display unit corresponding to the first touch point on the first touch induction unit. Certainly, it can also pop up at the position of the display unit corresponding to the second touch point; it can also pop up at any position of the display unit between the first and the second touch points; or it can also pop up at any pre-defined position of the display unit, such as at the border or vertical angle of the display unit.

In the implementation described above, the menu item of the menu is determined according to the operation on the objects displayed on the display unit.

Specifically, the type of the object is confirmed, and the menu item corresponding to the object is obtained according to the type of the object and the corresponding relations between the pre-defined types and the menu item.

If the object displayed on the display unit is an address book, the menu items corresponding to the address book can include “call”, “message”, “chat”, “e-mail” and so on. If the object displayed on the display unit is a picture, the menu items corresponding to the picture can include “zoom in”, “zoom out”, “send”, “delete” and so on. If the object displayed on the display unit is an icon, the menu items can include “open”, “delete” and so on.

The object on the display unit have at least one attribute information, and when operating the object, the attribute information according to the selected menu item is searched; the menu item according to the searched attribute information is executed; the object is operated.

The specific embodiment of the implementation is shown in FIG. 12. For an object which has at least one attribute information, the attribute information can be “cell phone number”, “e-mail address” and “QQ number” of the address book.

For the menu item “call”, the menu item can correspond to the attribute information of the cell phone number. When a call is performed, the cell phone number is picked up.

For the menu item “message”, the menu item can also correspond to the attribute information of the cell phone number. When a message is sent, the cell phone number is picked up.

For the menu item “chat”, the menu item corresponds to the attribute information of the QQ number. When a chat is performed using QQ, the QQ number is picked up.

For the menu item “e-mail”, the menu item corresponds to the attribute information of the e-mail address. When an e-mail is sent, the e-mail address is picked up.

Therefore, there is a corresponding relation between the menu items and the attribute information corresponding to the object for an object have at least one attribute information. The corresponding relations can be one-to-one or one-to-many, and the corresponding relations are confirmed according to the specific operation of the specific object.

In the embodiment, through operating the first and the second touch induction units, the operation which is similar to a click on the right button of a mouse is accomplished on the first and the second touch induction units, and the operation which is similar to a click on the left button of a mouse is accomplished simultaneously on the first touch induction unit on the front surface and the second touch induction unit. For example, after the first and the second touch induction units are pressed, the display unit will pop up a menu at the position corresponding to the press (equivalent to the menu popping up when a click is performed on the right button of a mouse). The menu can be in a form of a list, a circular type, a four-way type, an eight-way type and so on. Then the finger is kept swiping on the first and the second touch induction units to select one of the menu item functions. The problem that it is easy to cause false triggering when not only a menu is displayed on the first touch induction unit, but also a select to the menu need to be performed, will not occur. The problems that it is easy to cause false triggering on the single-sided touch induction unit and that the right button of a mouse on the single-sided unit is not working very well are solved, and it improves the efficiency of the touch control, and brings richer gestures, thereby making the users convenient to use. Certainly, the operation equivalent to the left button of a mouse can also be accomplished on the first surface of the first touch induction unit or the second surface of the second touch induction unit.

### Embodiment 5

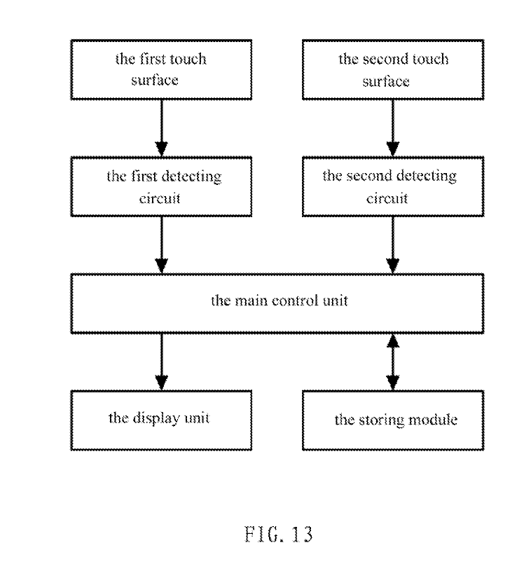

As shown in FIG. 13, an electronic equipment is provided in the embodiment of the present invention, comprising: a first touch induction unit and a display unit disposed on a first surface of the electronic equipment; a second touch induction unit disposed on a second surface of the electronic equipment; and a main control unit connected respectively to the first and the second touch induction units; wherein, the first touch induction unit includes a first touch surface and a first detecting circuit; the second touch induction unit includes a second touch surface and a second detecting circuit; the first surface is different with the second surface;

the second detecting circuit is used for obtaining the operation information of an operation on the second touch surface; and

the main control unit comprises:

a control module for generating a operation control information corresponding to the operation information;

an operation executing module for operating, according to the operation control information, an object displayed on the display unit.

The first touch surface here can specifically include hard coating, and the first detecting circuit can specifically be all of the structure of a conventional touch screen except the hard coating of the surface. The second touch surface can be the same as the first touch surface, and the implement structure of the second detecting circuit can also be the same as the implement structure of the first detecting circuit.

The operation information of an operation on the second touch induction unit is specifically an operation information of a click on the second touch induction unit.

Accordingly, the operation control information corresponding to the operation information of a click is specifically a menu popping up when the object is clicked.

The embodiment is an embodiment of an electronic equipment corresponding to the method shown in FIG. 3. The features of the above-mentioned method are appropriate for the embodiment of the electronic equipment and can achieve the same technical effects as the method of FIG. 3, which is unnecessary to go into details here.

### Embodiment 6

Corresponding to the method shown in FIG. 4, an electronic equipment is provided in the embodiment of the present invention, comprising: a first touch induction unit and a display unit disposed on a first surface of the electronic equipment; a second touch induction unit disposed on a second surface of the electronic equipment; and a main control unit connected respectively to the first and the second touch induction units; wherein, the first touch induction unit includes a first touch surface and a first detecting circuit; the second touch induction unit includes a second touch surface and a second detecting circuit; the first surface is different with the second surface;

the second detecting circuit is used for obtaining a first operation information of an operation on the second touch surface; and

the main control unit comprises a first control module for popping up, according to the first operation information, a menu on the display unit;

the first detecting circuit is used for obtaining a second operation information of an operation the menu on the first touch surface, or the second detecting circuit is also used for obtaining the second information of operating the menu on the second touch surface;

the main control unit further comprises: a second control module for generating an operation control information corresponding to the second operation information;

an operation executing module for operating, according to the operation control information, an object displayed on the display unit;

the first operation information is specifically an operation information of a click on the second touch surface, which is detected by the first detecting circuit;

the second operation information is specifically an operation information of a click or a swipe on the first touch surface, which is detected by the first detecting circuit or an operation information of a click or a swipe on the second touch surface, which is detected by the second detecting circuit; and

the menu includes at least one menu item, and the operation control information is specifically a selection information which indicates a menu item selected by a way of a click or a swipe on the first touch surface or a menu item selected by a way of a click or a swipe on the second touch surface.

The operation of a swipe is a rectilinear swipe or a curved swipe.

It is necessary to point out that all the features of the above-mentioned method shown in FIG. 4 are appropriate for this embodiment and can achieve the same technical effects as the method of FIG. 4, which is unnecessary to go into details here.

### Embodiment 7

Corresponding to the method shown in FIG. 8, an electronic equipment is provided in the embodiment of the present invention, comprising: a first touch induction unit and a display unit disposed on a first surface of the electronic equipment; a second touch induction unit disposed on a second surface of the electronic equipment; and a main control unit connected respectively to the first and the second touch induction units; wherein, the first touch induction unit includes a first touch surface and a first detecting circuit; the second touch induction unit includes a second touch surface and a second detecting circuit; the first surface is different with the second surface;

obtaining a operation information of an operation on the first and the second touch surfaces when the first and the second detecting circuits detect the first and the second touch surfaces are operated simultaneously;

the main control unit comprises:

a control module for generating a operation control information corresponding to the operating information; and

an operation executing module for operating, according to the operation control information, an object displayed on the display unit.

The operation information is an operation information of the first and the second touch induction units detecting being touched simultaneously; and

accordingly, the operation control information corresponding to the operation information is a menu popping up when the object is operated.

Additionally, the first and the second surfaces are two relative surfaces of the electronic equipment, and the first touch induction unit overlaps with the display unit; the operation information is an operation information of the first and the second touch surfaces being touched and a swipe simultaneously, which is detected by the first and the second detecting circuits. Accordingly, the operation control information is a control instruction corresponding to the operation information. This is the situation of not popping up a menu, such as directly zooming in a picture, zooming out a picture and so on.

In the cases of not popping up a menu, a projection distance between a first touch point on the first touch induction unit and a second touch point on the second induction unit is less than a pre-defined threshold when the first and the second touch induction units are touched; the swipes are swipes in a same direction on the first and the second touch induction units.

It is necessary to point out that all the features of the above-mentioned method shown in FIG. 8 are appropriate for this embodiment and can achieve the same technical effects, which is unnecessary to go into details here.

### Embodiment 8

Corresponding to the method shown in FIG. 11, an electronic equipment is provided in the embodiment of the present invention, comprising: a first touch induction unit and a display unit disposed on a first surface of the electronic equipment; a second touch induction unit disposed on a second surface of the electronic equipment; and a main control unit connected respectively to the first and the second touch induction units; wherein, the first touch induction unit includes a first touch surface and a first detecting circuit; the second touch induction unit includes a second touch surface and a second detecting circuit; the first surface is different with the second surface;

obtaining a third operation information of an operation on the first and the second surfaces when the first and the second detecting circuits detect the first and the second touch surfaces are operated simultaneously;

the main control unit comprises: a third control module for popping up, according to the third operation information, a menu on the display unit;

the first and the second detecting circuits obtain a fourth operation information of an operation the menu on the first and the second touch surfaces simultaneously;

the main control unit further comprises: a fourth control module for generating a operation control information corresponding to the fourth operation information; and

an operation executing module for operating, according to the operation control information, an object displayed on the display unit.

The third operating information is an operation information of the first and the second touch surfaces being touched simultaneously, which is detected by the first and the second detecting circuits;

the fourth operation information is an operation information of a click or a swipe on the first touch surface, which is detected by the first detecting circuit;

the menu includes at least one menu item, and the operation control information is specifically a selection information which indicates a menu item selected by a way of a click or a swipe on the first touch induction unit.

the third operating information is an operation information of the first and the second touch surfaces being touched simultaneously, which is detected by the first and the second detecting circuits;

the fourth operation information is an operation information of a swipe on the first and the second touch surfaces, which is detected by the first and the second detecting circuits simultaneously.

the relative operation control information is a menu item selected in a way of a swipe on the first and the second touch induction units simultaneously.

Preferably, the first and the second surfaces are two relative surfaces of the electronic equipment, and the first touch induction surface overlaps with the display unit, wherein, the menu pops up at the relative position of the display unit corresponding to the first touch point on the first touch induction unit.

The menu item of the menu is determined according to the operation on the objects displayed on the display unit; and

An object displayed on the display unit has at least one attribute information, and when the operation on the object is performed, corresponding attribute information is searched according to the menu item; the menu item is executed according to the searched attribute information; the operation on the object is performed.

It is necessary to point out that all the features of the above-mentioned method shown in FIG. 11 are appropriate for this embodiment and can achieve the same technical effects, which is unnecessary to go into details here.

Additionally, in the electronic equipments described above, the electronic equipment can also comprise:

a storing module for storing corresponding relations between the operation information and the operation corresponding to the operation information.

The main control unit obtains, according to the operation control information, an operation corresponding to the operation information from the table of the corresponding relations, and performs the operation to the objects displayed on the display unit.

Combined with a specific flowchart, the control and operation for the double touch induction units of the electronic equipment are illustrated below.

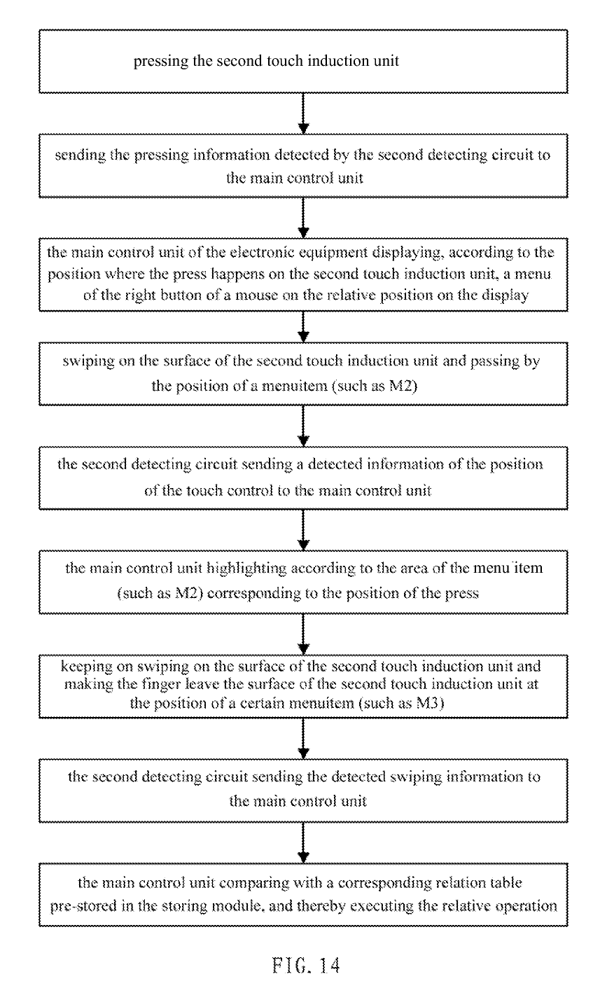

A flowchart of the first implementation of the control of operations towards the electronic equipment is shown in FIG. 14.

As shown in FIG. 14, the flowchart of the first implementation of the operational control for an electronic equipment is:

pressing the second touch induction unit lying on the back surface of the electronic equipment;

sending the pressing information detected by the second detecting circuit to the main control unit;

the main control unit popping up, according to the touch position of pressing on the second touch induction unit, a menu which is similar to the menu corresponding to the right button of a mouse, and displaying the menu at the touch position of the first display unit. As shown in FIG. 4, a four-way menu is popped up with the touch point at the center;

selecting a corresponding menu item if a rectilinear swipe in a certain direction is performed on the second touch induction unit at this moment, such as a swipe to any of a menu item in M1-M4 in FIG. 4; for example, in FIG. 5, M1 represents “zoom in”; M3 represents “send”; M4 represents “delete” and so on; certainly, these descriptions here is just some examples which do not give a specific limit to the functions of the menu of M1-M4 and can define in any manner; similarly, in FIG. 6, M1 can also represents “zoom in”; M2 represents “zoom out”; M3 represents “send”; M4 represent “delete” and so on; no the specific limitation will be given here to the functions of the menu in M1-Mn, which can define in any manner, or using the circular menu as an example, on the back surface of the electronic equipment, a touch is performed by a press at first; then a circular swipe is performed with the press point at the center; finally a stop is given at a certain position (such as the position of any of a menu in M1-Mn) and then the finger is loosed to select the correspond menu item;

the second detecting circuit sending a detected swiping information to the main control unit;

the main control unit comparing with, according to the direction of the swipe and the menu item confirmed by the operation of the swipe, the corresponding relation table pre-storing in the storing module, and performing the relative operation,

wherein, the corresponding relation table stores the corresponding relations between the operation control information and the corresponding operation; if the operation control information is a menu item, the operation corresponding to the operation control information is the function to execute the menu item; using FIG. 5 as an example, if the menu item M2 is selected, the operation control information refers to the operation that M2 is selected; the operation corresponding to the menu item M2 can be “zoom in”, “zoom out”, “send”, “delete” and so on.

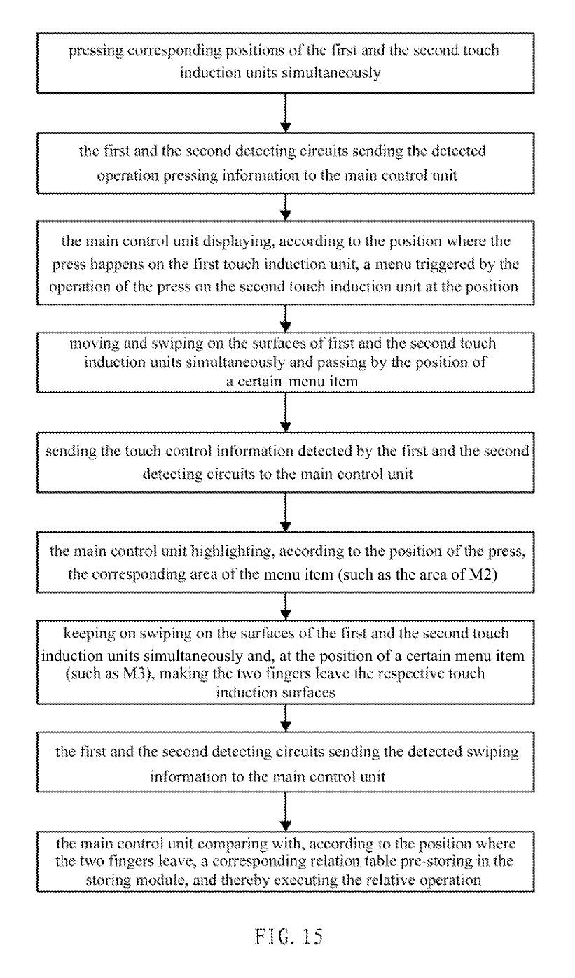

As shown in FIG. 15, the flowchart of the first implementation of the operation and control for an electronic equipment is:

pressing corresponding positions of the first and the second touch induction units simultaneously;

the first and the second detecting circuits sending the detected operation pressing information to the main control unit;

the main control unit displaying, according to the position where the press happens, the menu of the right button of a mouse triggered by the operation of a press on the second touch induction unit at the relative position of the display unit of the first touch induction unit, wherein the relative position is the position where the operation of the press happens on the first touch induction unit or is the position where the operation of the press happens on the second touch induction unit;

performing a rectilinear swipe on the first and the second touch induction units simultaneously, and passing by a certain menu item of the menu shown in FIG. 5, such as M2, or pressing the first and the second touch induction units simultaneously, then swiping around the press point in a circular motion, stopping at a certain position of the menu shown in FIG. 6 finally (such as any of a position in M1-Mn) and loosing the finger to select a menu item;

the first and the second detecting circuits sending the detected touch control information to the main control unit;

the main control unit comparing with the corresponding relation table pre-storing in the storing module and thereby executing relative operations;

wherein, what stored in the corresponding relation table is the corresponding relations between the operation control information and the relative operations, and if the operation control information is a menu item, the operations corresponding to the operation control information is the function for executing the menu item; taking the FIG. 6 as an example, if the menu item M3 is selected at last, the operation control information refers to the operation of selecting M3, and the operation corresponding to the menu item M3 can be “zoom in”, “zoom out”, “send” or “delete”.

In the methods of the present invention described above, such as a pressing+four-way rectilinear swipe shown in FIG. 5 and a pressing+circular swipe shown in FIG. 6 and FIG. 7, the same touch control operation represents different applications in different application scenarios. For example, when seeing a picture, it represents zooming the picture in to press the first and the second touch induction units simultaneously and give a swipe upward; the same movement represents sending the selected card out when seeing an address book; the same movement represents turning the music up when listening to music. If the pressing a four-way method is performed, after a press is performed, four arrows will appear at the position of the press, and there are texts or figures to show the difference of the functions respectively. If a user has already remembered the definitions, the four-way arrow and its texts or figures can be not displayed.

Above all, in the solutions of the present invention, the problem of false triggering which often occurs in the single-sided touch induction unit and the problem that the right button of a mouse of a single-sided touch induction unit is not working very well are solved through accomplishing the operation equivalent to the left button of a mouse on the front surface of the touch induction unit and accomplishing the operation equivalent to the right button of a mouse on the back surface of the touch induction unit in the double-sided touch equipment, which improves the efficiency of the touch control operation, thereby bringing more gestures of operation.

The embodiments described above are the preferable embodiments of the present invention, and it should be pointed out that a number of improvements and embellishments can be performed by the ordinary technical persons in the art under the principal of the present invention, which should also be regarded as a scope of the protection of the present invention.

1. A method for operating and controlling an electronic equipment that is provided with a first touch induction unit and a display unit disposed on a first surface and a second touch induction unit disposed on a second surface, and the first surface is different than the second surface, the method comprising:
obtaining an operation information of an operation on the second touch induction unit;
generating an operation control information corresponding to the operation information; and
operating, according to the operation control information, an object displayed on the display unit.

2. The method according to claim 1, wherein,
the operation information of an operation on the second touch induction unit is specifically an operation information of a click on the second touch induction unit; and
the operation control information corresponding to the operation information of a click is a menu popping up when the object is clicked.

3. A method for operating and controlling an electronic equipment that is provided with a first touch induction unit and a display unit disposed on a first surface and a second touch induction unit disposed on a second surface, and the first surface is different than the second surface, the method comprising:
obtaining a first operation information of an operation on the second touch-sensitive unit;
popping up, according to the first operation information, a menu on the display unit;
obtaining a second operation information of an operation the menu on the first touch induction unit or the second touch induction unit;
generating an operation control information corresponding to the second operation information; and
operating, according to the operation control information, an object displayed on the display unit.

4. The method according to claim 3, wherein,
the first operation information is specifically an operation information of a click on the second touch induction unit;
the second operation information is an operation information of a click or a swipe on the first touch induction unit or an operation information of a click or a swipe on the second touch induction unit; and
the menu includes at least one menu item, and the operation control information is a selection information which indicates the menu item selected by a way of a click or a swipe on the first touch induction unit or a menu item selected by a way of a click or a swipe on the second touch induction unit.

5. The method according to claim 4, wherein, the operation of a swipe is a rectilinear swipe or a curved swipe.

6. A method for operating and controlling an electronic equipment that is provided with a first touch induction unit and a display unit disposed on a first surface and a second touch induction unit disposed on a second surface, and the first surface is different than the second surface, the method comprising:
obtaining an operation information of an operation on the first and the second touch induction units when the first and the second touch induction units detect being operated simultaneously;
generating a operation control information corresponding to the operation information; and
operating, according to the operation control information, an object displayed on the display unit.

7. The method according to claim 6, wherein,
the operation information is an operation information of the first and the second touch induction units detecting being touched simultaneously; and
the operation control information corresponding to the operation information is a menu popping up when the object is operated.

8. The method according to claim 6, wherein,
the first and the second surfaces are two relative surfaces of the electronic equipment,
the first touch induction unit overlaps with the display unit, characterized in that,
the operation information is an operation information of the first and the second touch induction units simultaneously detecting being touched and a swipe; and
the operation control information is a control instruction corresponding to the operation information.

9. The method according to claim 8, wherein, a projection distance between a first touch point on the first touch induction unit and a second touch point on the second induction unit is less than a pre-defined threshold when the first and the second touch induction units are touched;
the swipes are swipes in a same direction on the first and the second touch induction units.

10. A method for operating and controlling an electronic equipment, that is provided with a first touch induction unit and a display unit disposed on a first surface and a second touch induction unit disposed on a second surface, and the first surface is different than the second surface, the method comprising:
obtaining a third operation information of an operation on the first and the second touch induction units when the first and the second touch induction units detect being operated simultaneously;
popping up, according to the third operation information, a menu on the display unit;
obtaining a fourth operation information of an operation the menu on the first and the second touch induction units simultaneously;
generating an operation control information corresponding to the fourth operating information; and
operating, according to the operation control information, an object displayed on the display unit.

11. The method according to claim 10, wherein,
the third operating information is an operation information of the first and the second touch induction units detecting being touched simultaneously;
the fourth operation information is an operation information of a click or a swipe on the first touch induction unit or an operation information of a swipe on the first and the second touch-sensitive units simultaneously; and
the menu includes at least one menu item, and the operation control information is a selection information which indicates the menu item selected by a way of a click or a swipe on the first touch induction unit or a menu item selected by a way of a swipe on the first and the second touch induction units simultaneously.

12. The method according to claim 11, wherein,
the first and the second surfaces are two relative surfaces of the electronic equipment;
the first touch induction overlaps with the second touch induction unit, such that, the menu pops up at the relative position of the display unit corresponding to the first touch point on the first touch induction unit.

13. The method according to claim 1, wherein,
the menu item of the menu is determined according to the operation on the displayed object on the display unit; and
the object on the display unit has at least one attribute information, and when the object is operated, the attribute information according to the selected menu item is searched, and the selected menu item is executed according to the searched attribute information, and the object is operated.

14. An electronic equipment, comprising: a first touch induction unit and a display unit disposed on a first surface of the electronic equipment; a second touch induction unit disposed on a second surface of the electronic equipment; and a main control unit connected respectively to the first and the second touch induction units; such that, the first touch induction unit includes a first touch surface and a first detecting circuit; the second touch induction unit includes a second touch surface and a second detecting circuit; the first surface is different than the second surface; the second detecting circuit is used for obtaining the operation information of an operation on the second touch surface; and
the main control unit comprises:
a control module for generating a operation control information corresponding to the operation information; and,
an operation executing module for operating, according to the operation control information, an object displayed on the display unit.

15. An electronic equipment, comprising: a first touch induction unit and a display unit disposed on a first surface of the electronic equipment; a second touch induction unit disposed on a second surface of the electronic equipment; and a main control unit connected respectively to the first and the second touch induction units; such that, the first touch induction unit includes a first touch surface and a first detecting circuit; the second touch induction unit includes a second touch surface and a second detecting circuit; the first surface is different than the second surface;
the second detecting circuit is used for obtaining a first operation information of an operation on the second touch surface; and
the main control unit comprises a first control module for popping up, according to the first operation information, a menu on the display unit; wherein
the first detecting circuit is used for obtaining a second operation information of an operation the menu on the first touch surface, or the second detecting circuit is also used for obtaining the second information of operating the menu on the second touch surface;
the main control unit further comprises: a second control module for generating an operation control information corresponding to the second operation information;
an operation executing module for operating, according to the operation control information, an object displayed on the display unit.

16. The electronic equipment according to claim 15, wherein,
the first operation information is an operation information of a click on the second touch surface, which is detected by the first detecting circuit;
the second operation information is an operation information of a click or a swipe on the first touch surface, which is detected by the first detecting circuit or an operation information of a click or a swipe on the second touch surface, which is detected by the second detecting circuit; and
the menu includes at least one menu item, and the operation control information is a selection information which indicates a menu item selected by a way of a click or a swipe on the first touch surface or a menu item selected by a way of a click or a swipe on the second touch surface.

17. An electronic equipment, comprising: a first touch induction unit and a display unit disposed on a first surface of the electronic equipment; a second touch induction unit disposed on a second surface of the electronic equipment; and a main control unit connected respectively to the first and the second touch induction units; characterized in such that, the first touch induction unit includes a first touch surface and a first detecting circuit; the second touch induction unit includes a second touch surface and a second detecting circuit; the first surface is different than the second surface;
obtaining an operation information of an operation on the first and the second touch surfaces when the first and the second detecting circuits detect the first and the second touch surfaces are operated simultaneously;
the main control unit comprises:
a control module for generating a operation control information corresponding to the operating information; and
an operation executing module for operating, according to the operation control information, an object displayed on the display unit.

18. The electronic equipment according to claim 17, wherein, the first and the second surfaces are two relative surfaces of the electronic equipment, and the first touch induction unit overlaps with the display unit; the operation information is an operation information of the first and the second touch surfaces being touched and a swipe simultaneously, which is detected by the first and the second detecting circuits; and
the operation control information is a control instruction corresponding to the operation information.

19. An electronic equipment, comprising: a first touch induction unit and a display unit disposed on a first surface of the electronic equipment; a second touch induction unit disposed on a second surface of the electronic equipment; and a main control unit connected respectively to the first and the second touch induction units; such that, the first touch induction unit includes a first touch surface and a first detecting circuit; the second touch induction unit includes a second touch surface and a second detecting circuit; the first surface is different than the second surface;
obtaining a third operation information of an operation on the first and the second surfaces when the first and the second detecting circuits detect the first and the second touch surfaces are operated simultaneously;
the main control unit comprises: a third control module for popping up, according to the third operation information, a menu on the display unit;
the first and the second detecting circuits obtain a fourth operation information of an operation the menu on the first and the second touch surfaces simultaneously;
the main control unit further comprises: a fourth control module for generating a operation control information corresponding to the fourth operation information; and
an operation executing module for operating, according to the operation control information, an object displayed on the display unit.

20. The electronic equipment according to claim 19, wherein, the third operating information is an operation information of the first and the second touch surfaces being touched simultaneously, which is detected by the first and the second detecting circuits;
the fourth operation information is an operation information of a click or a swipe on the first touch surface, which is detected by the first detecting circuit, or an operation information of a swipe on the first and the second touch surfaces, which is detected by the first and the second detecting circuits simultaneously; and
the menu includes at least one menu item, and the operation control information is specifically a selection information which indicates a menu item selected by a way of a click or a swipe on the first touch induction unit or a menu item selected by a way of a swipe on the first and the second touch surfaces simultaneously.
